(19) United States
(12) Patent Application Publication
(10) Pub. No.: US 2007/0236969 A1
(43) Pub. Date: Oct. 11, 2007

(54) AIRCRAFT POWER CONVERTOR WITH IMPROVED VOLTAGE OUTPUT CHARACTERISTICS

(75) Inventor: John DeWitte Cottingham III, Anderson, SC (US)

Correspondence Address: JAMES D. STEVENS;REISING, ETHINGTON, BARNES, KISSELLE, P.C., P.O. BOX 4390, TROY, MI, 48099, US

(73) Assignee: CHAMPION AEROSPACE, INC., Liberty, SC (US)

(21) Appl. No.: 11/693,016

(22) Filed: Mar. 29, 2007

Related U.S. Application Data
(60) Provisional application No. 60/743,906, filed on Mar. 29, 2006.

(51) Int. Cl. H02M 1/12

(52) U.S. Cl. 363/39

(57) ABSTRACT

A multi-phase AC-DC aircraft power converter having an input filter, power transformer, rectifier, output filter, and dummy load that provides improved voltage regulation across a range of output current loads. The transformer includes a primary and a pair of secondary windings. The input filter receives multi-phase AC input power and is connected to supply filtered input power to the primary of the transformer, with the secondary windings being connected to the rectifier. The rectifier provides a DC output that is connected to the output filter. The dummy load is connected at the output filter and is designed to draw sufficient current from the DC output such that the converter operates at a substantially linear I-V characteristic across a range of loads extending from a low load of less than 5 Amps to a high load of greater than 50 Amps.

### CROSS-REFERENCE TO RELATED APPLICATION

This application claims the priority of U.S. Provisional Application No. 60/743,906, filed Mar. 29, 2006, the entire contents of which are hereby incorporated by reference.

### TECHNICAL FIELD

This invention relates generally to power supplies and, more specifically, to power supplies used onboard aircrafts to convert AC to DC power that is used to run various aircraft systems.

### BACKGROUND OF THE INVENTION

FIG. 1 depicts a prior art aircraft power supply in the form of an AC-DC power converter that receives three-phase input AC power from an aircraft generator. This input supply can be three-phase 200 VAC at 400 Hz as is typical. The converter steps down this input across a power transformer T1, rectifies the secondary voltage, and filters it to provide a 28 VDC output. More specifically, the three-phase input is provided through a L-network input filter and is connected to the power transformer T1 primary in a Wye configuration. The transformer has two secondaries, one connected in using a Delta topology and the other in a Wye topology. These secondaries are connected to a rectifier in the form of a bank of power diodes CR1-CR12 that provide full-wave rectification of the secondary voltage, with the low voltage ends connected to ground through an interphase transformer T2 that operates to magnetically couple the Delta and Wye waveforms together. The interphase transformer includes a pair of higher voltage taps that are connected to a failure sensing relay Z1 that provides converter status information for use by, for example, a FADEC system. The positive output of the rectifier is connected to a 40 Ω, 25 W bleed resistor R1 that limits the output voltage at no or low load conditions, and a π filter network that includes two 94 μF capacitors separated by a 0.1 mΩ, 0.3 μH inductor (measured at 1 kHz). In FIG. 1, B1 is a fan motor used for cooling of the circuit components, J1 is a receptacle (such as an MS3102R-20-17P), and TB1 is a terminal board.

A typical prior art circuit constructed according to the schematic of FIG. 1 has an output voltage characteristic that is heavily dependent upon the load. For example, for a circuit that nominally provides a 28 VDC output, the no load output of the circuit may be 33 VDC, whereas a heavily loaded output (i.e., output current >50 amps) may be below 27 VDC with the output voltage continuing to fall with increasing load. This output voltage versus load curve is mostly linear except at low loads (i.e., less than 5 amps). The result is that the power supply provides limited regulation of about 28% (i.e., up to about an 8 volt swing around a nominal 28 VDC). Furthermore, the ripple voltage seen at the output of the converter is typically about 1.5 Vp-p (volts peak-to-peak). Although this ripple voltage characteristic may meet the applicable requirements such as MIL-STD 704, nonetheless these amounts of high power ripple can undesirably affect communications and other on-board systems.

Traditionally, improved regulation of output voltage level and ripple has been achieved using closed-loop feedback control topologies such as linear regulators, triggered SCRs, and PWM or other switch-mode voltage regulators. These feedback systems monitor the output voltage and adjust their operation accordingly to achieve a well regulated output. Typical output characteristics for a 28 VDC/100 amp supply include regulation of voltage to within 1 VDC and a ripple voltage of 0.4 Vp-p. However, improved regulation using these circuit configurations can have some disadvantages. For example, linear regulators have relatively low efficiency with much power being lost in the form of heat, and this may require significant thermal management efforts. Also, switch mode supplies can generate significant EMI and they require the use of active devices which can have significantly less reliability than passive devices such as resistors, capacitors, diodes, and inductors. This reliability can be important in aircraft applications.

### SUMMARY OF THE INVENTION

In accordance with the invention, there is provided a multi-phase AC-DC aircraft power converter having an input filter, power transformer, rectifier, output filter, and dummy load that provides improved voltage regulation across a range of output current loads. The transformer includes a primary and a pair of secondary windings. The input filter receives multi-phase AC input power and is connected to supply filtered input power to the primary of the transformer, with the secondary windings being connected to the rectifier. The rectifier provides a DC output that is connected to the output filter. The dummy load is connected at the output filter and is designed to draw sufficient current from the DC output such that the converter operates at a substantially linear I-V characteristic across a range of loads extending from a low load of less than 5 Amps to a high load of greater than 50 Amps.

In one embodiment, the dummy load can be one or more resistors having a total resistance sufficient to draw the needed amount of current. Also, in another embodiment, the output filter can be provided with a high storage output capacitor (e.g., 1000 μF or more) that filters ripple current from the rectifier and provides voltage ripple regulation of less than 1.0 Vp-p.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is schematic of a prior art three-phase AC-DC aircraft power converter that operates off a nominal 200 VAC at 400 Hz and provides a 28 VDC output designed to handle loads from 0-100 Amps;

FIG. 2 is a schematic of a three-phase AC-DC aircraft power converter constructed in accordance with the invention; and

FIG. 3 is a plot comparing the output I-V characteristics of the circuits of FIGS. 1 and 2.

### DETAILED DESCRIPTION OF THE PREFERRED EMBODIMENTS

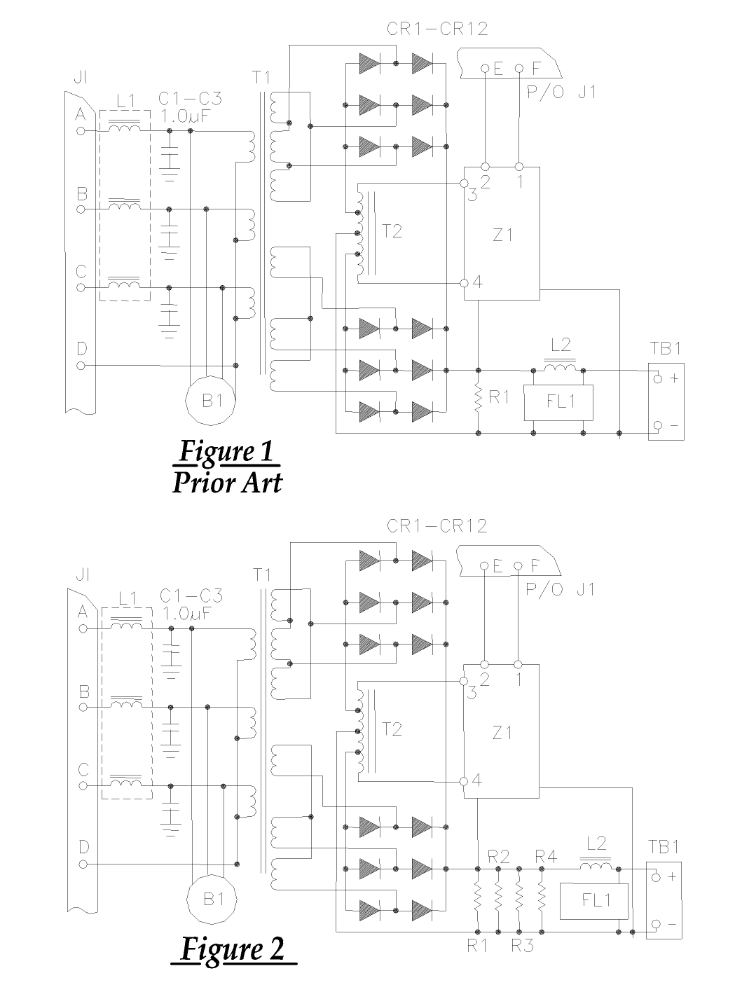

FIG. 2 depicts an embodiment of the present invention. This circuit is similar to the prior art converter of FIG. 1 in that it uses the same input filter, Wye to Delta-Wye transformer, and rectifier circuit arrangement to convert three-phase 200 VAC at 400 Hz to 28 VDC, 0-100 Amp output. It also includes the interphase transformer T2, failure sensing relay Z1, and the fan motor B1, receptacle J1, and terminal board TB1 connected as discussed above. However, unlike the FIG. 1 prior art circuit, the circuit of FIG. 2 utilizes a combined output stage dummy load and larger capacity filter to provide improved voltage level and ripple regulation. The improved voltage level regulation is achieved using a lower ohm load resistance of 10 Ω (implemented as shown in FIG. 2 by four 40 Ω 25 W resistors in parallel). This dummy load acts as more than just a bleed resistor—it draws a significant enough current even at no load on the converter output so that the converter is always operating in the mostly linear portion of its inherent output voltage versus load current characteristic. In this embodiment, the dummy load draws enough current through the power diodes CR1-CR12 to drive them towards their full forward conduction voltage (e.g., 0.7 volts), even keeping them slightly warmed so that their voltage characteristic does not change much even at full output load. The turns ratio of the transformer T1 is reduced slightly (about 2-3%) to offset the reduced no load output voltage that results from this dummy load. This can be done by reducing each of the transformer T1 primary windings by 2-3 turns (out of a typical, approximate 100 turns).

In accordance with the embodiment of FIG. 2, this use of a dummy load to improve voltage level regulation is provided in combination with an L-network output filter that uses a 1.9 mΩ, 53.8 μH inductor (measured at 1 kHz) in the positive voltage output line followed by a 3000 μF capacitor connected across the output terminals. This increased capacity filter in combination with the dummy load provides about 30-60% better voltage level regulation and about 50-95% better voltage ripple regulation. For example, the circuit shown in FIG. 2 can provide an output voltage variation of about 3-5 Volts from no load to 100 Amps and at the same time provide a ripple amplitude of no more than 1.0 Vp-p, preferably no more than 0.5 Vp-p, and in a highly preferred embodiment, no more than 0.2 Vp-p. Furthermore, this voltage regulation is accomplished using only passive devices and without feedback. Thus, it provides a regulated output voltage similar to that achieved by closed-loop control feedback schemes without the low efficiency of linear regulators, the EMI of switch mode supplies, and the reduced reliability of these and SCR-based supplies.

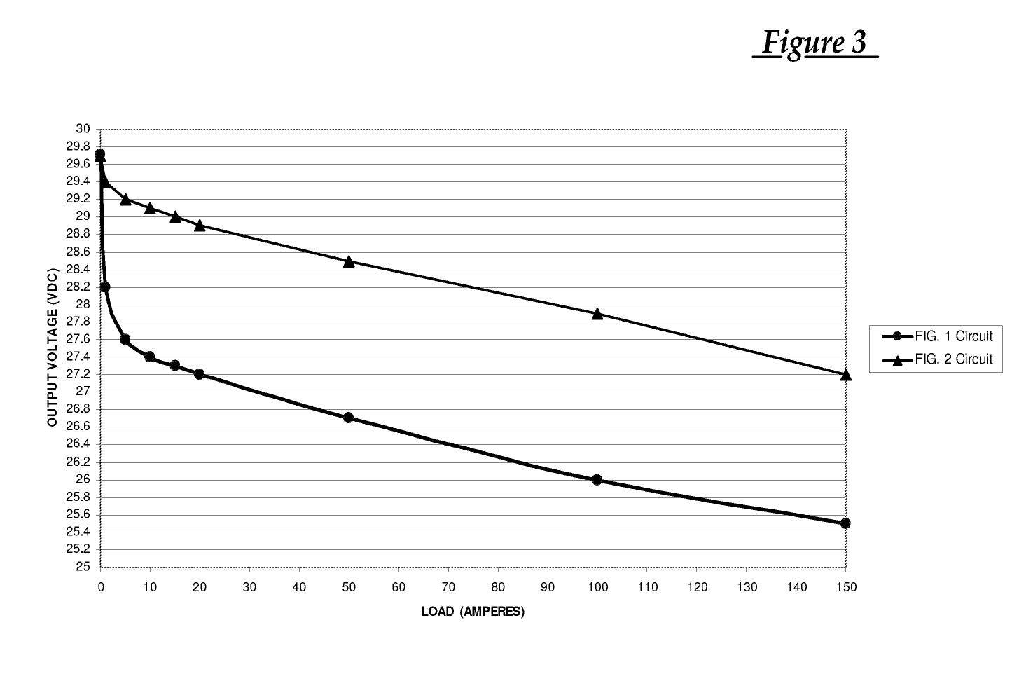

FIG. 3 depicts a comparison of the output I-V characteristic of the prior art circuit of FIG. 1 with the embodiment of FIG. 2. As can be seen, the I-V characteristic of the FIG. 2 circuit is substantially linear across the range from low loads (below 5 Amps) to high loads (above 50 Amps) all the way through 150 Amps, and is highly linear for all output loads of 5 Amps or more. The regulation provided by the FIG. 2 circuit is ±1.0 VDC over the range of 1 to 150 Amps and only rises to ±1.25 VDC over the entire range of 0 (no load) to 150 Amps.

It is to be understood that the foregoing description is of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the dummy load resistance can be placed after the output filter rather than before it as shown in FIG. 2. Also, other output filter configurations can be used as long as they provide a level of voltage ripple that is acceptable for a particular application. Also, the specific component values and schematic design disclosed herein are given to provide a specific example of an embodiment that can be used for one particular application—a 200 VAC to 28 VDC aircraft power supply. Other applications will use other components, component values, and circuit designs. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. In a multi-phase AC-DC aircraft power converter having an input filter, power transformer, rectifier, and output filter, wherein the transformer includes a primary and a pair of secondary windings, said input filter receiving multi-phase AC input power and being connected to supply filtered input power to the primary of the transformer, said secondary windings being connected to the rectifier, with the rectifier providing a DC output connected to the output filter, characterized in that:
said converter includes a dummy load at the output filter, said dummy load drawing sufficient current from the DC output such that said converter operates at a substantially linear I-V characteristic across a range of loads extending from a low load of less than 5 Amps to a high load of greater than 50 Amps.

2. An aircraft power converter as set forth in claim 1, wherein the output filter includes a high storage output capacitor that filters the DC output from the rectifier and provides voltage ripple regulation of less than 1.0 Vp-p.

3. An aircraft power converter as set forth in claim 2, wherein the output capacitor has a capacitance of at least 1000 μF and provides voltage ripple regulation of less than 0.5 Vp-p.

4. An aircraft power converter as set forth in claim 2, wherein the output filter includes an inductor in series with the DC output.

5. An aircraft power converter as set forth in claim 4, wherein the output filter comprises an L-network output filter.

6. An aircraft power converter as set forth in claim 1, wherein the dummy load comprises a plurality of high-wattage resistors in parallel with each other.

7. An aircraft power converter as set forth in claim 1, wherein the rectifier comprises a plurality of diodes connected to effect full-wave rectification of the voltage from the secondary windings, and wherein the dummy load comprises one or more resistors having a total resistance such that it draws sufficient current through the diodes at zero output current load to operate the diodes at their full forward conduction voltage.

8. An aircraft power converter as set forth in claim 1, wherein the primary is connected to receive input power in a Wye configuration, one of the secondary windings is connected in a Delta configuration, and the other of the secondary windings is connected in a Wye configuration, and wherein the rectifier comprises two groups of diodes, each group connected to one of the secondary windings to provide full wave rectification, said diodes being connected at their low voltage ends to ground via an interphase transformer.

9. An aircraft power converter as set forth in claim 1, wherein the converter receives an unregulated three-phase 200 VAC at 400 Hz and provides a DC output having a voltage variation of no more than 3 volts across a range of loads from zero to 150 Amps of current with a voltage ripple of less than 0.5 Vp-p.

10. An aircraft power converter as set forth in claim 1, wherein the converter contains only passive components without feedback.

11. A multi-phase AC-DC aircraft power converter, comprising:
a plurality of input lines for receiving three-phase AC input power;
a power transformer having a primary and a pair of secondary windings, said primary being connected to said input lines in a Wye configuration to receive the three-phase AC input power;
a rectifier comprising a plurality of diodes connected as a full-wave rectifier to thereby provide a DC output, said secondary windings of said transformer including a first winding connected to a first group of said diodes in a Delta configuration and a second winding connected to a second group of said diodes in a Wye configuration, wherein said diodes being connected to ground through an interphase transformer;
a resistance load connected across said DC output of said rectifier; and
an output filter including at least one capacitor connected that filters the DC output from the rectifier and provides voltage ripple regulation;
wherein said resistance load draws sufficient current through said diodes to operate said diodes at their full forward conduction voltage regardless of whether any external load is present.

12. An aircraft power converter as set forth in claim 11, wherein the output filter includes a series inductor before the capacitor, the capacitor has a capacitance of 1000 μF or more, and the output filter provides voltage of less than 1.0 Vp-p.

13. An aircraft power converter as set forth in claim 11, wherein the converter contains only passive components without feedback.

14. An aircraft power converter as set forth in claim 11, wherein said resistance load draws sufficient current from the DC output such that the converter operates at a substantially linear I-V characteristic across a range of loads extending from a low load of less than 5 Amps to a high load of greater than 50 Amps.
